(19) United States
(12) Patent Application Publication
(10) Pub. No.: US 2012/0176666 A1
(43) Pub. Date: Jul. 12, 2012

(54) LASER APPARATUS AND METHOD TO GENERATE UV LASER LIGHT

(75) Inventors: Dirk Sutter, Rottweil (DE); Ivo Zawischa, Villingen-Schwenningen (DE); Chuong Tan, Schramberg (DE)

(73) Assignee: TRUMPF LASER GMBH + CO. KG, Schramberg (DE)

(21) Appl. No.: 13/346,903

(22) Filed: Jan. 10, 2012

Related U.S. Application Data
(60) Provisional application No. 61/431,610, filed on Jan. 11, 2011.

(51) Int. Cl. G02F 1/37; G02F 1/355; G02F 1/35

(52) U.S. Cl. 359/329

(57) ABSTRACT

This invention relates generally to laser systems that produce UV light and their methods of use. The phase matching of the conversion process has a broad temperature bandwidth so that precise temperature stabilization is not necessary to obtain a stable efficiency and a non-deformed laser beam with fast power modulation at high energies.

### CROSS-REFERENCE TO RELATED APPLICATIONS

This disclosure claims priority to U.S. provisional application 61/431,610 filed Jan. 11, 2011. All references cited in this specification, and their references, are incorporated by reference herein in their entirety where appropriate for teachings of additional or alternative details, features, and/or technical background.

### FIELD OF INVENTION

This invention relates generally to laser systems that produce UV light and their methods of use.

### BACKGROUND OF THE INVENTION

Lasers have become appreciated as versatile tools in scientific, medical, military, and industrial applications. Frequently, high power, brightness and efficiency are required to solve the given task satisfactorily or economically.

Lamp or diode pumped solid state lasers emitting in the wavelength range 1 μm to 1.1 μm have been established to fulfill these demands. For some applications, however, a wavelength of 1.0 μm to 1.1 μm may not be suitable as the absorption in the material to be treated is too low, or a small enough focus or high optical pattern resolution cannot be reached. Smaller foci, higher resolution, and often higher absorption can be reached at significantly shorter wavelengths, but shorter wavelengths can rarely be generated directly with the required power, brightness or efficiency.

The shortage of suitable short wavelength laser sources can be remedied by non-linear harmonic generation. The non-linear harmonic generation utilizes the large non-linear dielectric response of certain materials, such as non-linear crystals, at the incidence and transmission of high intensity light fields. Encyclopedia of Laser Physics, Nonlinear Optics, available at http://www.rp-photonics.com/topics_nonlinear.html.

Due to the sensitivity of harmonic generation to temperature changes, precise temperature stabilization of the harmonic generator is required. Difficulties in stabilizing the temperature are increased due to the absorption of the laser light in the non-linear crystal, which are generally higher at shorter wavelengths and cause an inhomogeneous temperature distribution in the crystal. At high ultraviolet (UV) powers, the temperature differences within the input beam overlap region, e.g. across the beam diameter or along the crystal length, will exceed the tolerable fraction of the phase matching bandwidth such that the conversion efficiency is necessarily reduced locally at one point or another. This leads to reduced overall conversion efficiency and a deformation of the generated UV-beam as quantified by the M² factor.

The heat can only be removed from the crystal at one or more of its sides (but not directly in the crystal volume); therefore, temperature stabilization can only occur at the sides of the crystal or on the crystal mount where temperature can be measured and heat can be removed or generated.

As light is absorbed within the crystal, there will be a heat flow from the beam overlap region to the temperature stabilized crystal sides and a corresponding temperature difference. This difference can be even larger than the temperature differences in the overlap region, and lead to a reduced overall phase matching and conversion efficiency.

This temperature difference can be and is typically compensated for in steady-state systems where average power and heat load is kept constant or at least constant over the length of thermal reaction time of the crystal, crystal mount, and control system. However, often the average power of a laser needs to be modulated quickly (from microseconds to few milliseconds) and the thermal reaction time of the system is much larger (from several milliseconds to many seconds). This leads to a delayed or distorted modulation of the generated harmonic power.

The distortion could be solved by modulating the UV-laser beam after it has been produced; however, modulation after production would require the conversion crystal to be permanently exposed to the UV laser. Permanent exposure reduces the operational life spans of the conversion crystals and the optics.

Deki et al. (Conference on Lasers and Electro-Optics (CLEO® 2000), May 7-12, 2000, San Francisco, TOPS volume 39, Abstract CTuA16, pp. 148-149) describes use of a wavelength of about 1030 nm (1.03 μm) as fundamental wavelength in third harmonic generation using a type I lithium triborate (LBO) crystal. In contrast, the present disclosure describes use of a wavelength of about 1047 nm (1.047 μm), which advantageously provides a temperature bandwidth for the type I interaction that is larger than that described by Deki et al. at a given phase-matching temperature at or above room temperature, for example at 47° C. (320 K).

Pryalkin et al. (Quantum Electronica, 34(6):565-568 (2004)) describes use of a wavelength of 1030 nm (1.030 μm) for third harmonic generation in an LBO crystal. Beam propagation in the x-y plane of the LBO (theta=90° in contrast to 75°) is possible together with a large temperature bandwidth at a phase-matching temperature at or above room temperature. Pryalkin et al. mentions that other wavelengths may change the situation towards a noncritical temperature phase-matching within the x-y plane, but they do not provide details or rationale as to which other wavelengths would effect this change. The present disclosure, on the other hand, uses the common and easy-to-use theta-noncritical angular orientation of the LBO, which advantageously allows for large tolerances in theta and while still providing a large temperature bandwidth.

Therefore, there exists a need for a laser system, which incorporates a broad temperature bandwidth in the non-linear crystal, thereby maintaining a high conversion efficiency even after the application of the thermal load.

### SUMMARY OF THE INVENTION

It is therefore the intention of the present invention to provide a laser apparatus for providing a UV-laser beam that does not require significant temperature stabilization of the harmonic generator, and the above mentioned problems do not occur.

Embodiments of the present invention use a harmonic generator to create a third harmonic generation, wherein a temperature stabilization more precise than +/−1 K is not required in the harmonic generator to achieve a third harmonic generation conversion efficiency percentage between about twenty-five percent (25%) to about forty percent (40%) and stabilize that conversion efficiency percentage to within about three percentage points during the third harmonic generation.

In one embodiment, the harmonic generator comprises at least one first non-linear optical element and at least one second non-linear optical element, and the fundamental wavelength, λ₁, is between 1 μm and 1.1 μm (1000 nm and 1100 nm). The first non-linear optical element is capable of producing a second harmonic wavelength, λ₂, between about 0.5 μm and about 0.55 μm (500 nm and 550 nm), and the second non-linear element is capable of producing a third harmonic wavelength, λ₃, between about 0.33 μm and about 0.37 μm (330 nm and 370 nm).

In another embodiment, the fundamental wavelength, λ₁, is equal to 1.03+/−0.005 μm, and the second harmonic wavelength, λ₂, is equal to 0.515+/−0.0025 μm, and λ₁ and λ₂ have the propagation direction of about θ=90° and about φ=40°, and λ₁ and λ₂ are ordinarily polarized.

In one embodiment, the average power of the third harmonic generation is greater than 5 W, and the beam deformation M² factor is less than about 1.3.

In one embodiment, the central phase matching temperature is between about 20° and 60° C., and at least one of the first or the second non-linear optical element comprises lithium triborate, which can designated by the empirical formula LiB₃O₅ or the abbreviation “LBO”, or beta-barium borate, which can be designated by the empirical formula β-BaB₂O₄ or the abbreviation “BBO”.

### BRIEF DESCRIPTION OF DRAWINGS

Illustrative embodiments of the present invention are described below with reference to the attached drawings, which are incorporated by reference herein.

FIG. 1 shows a harmonic generator using two non-linear crystals.

FIG. 2 shows an example of a wave propagation in Type I phase-matched SFG.

FIG. 3 shows an example of a wave propagation in Type II phase-matched SFG.

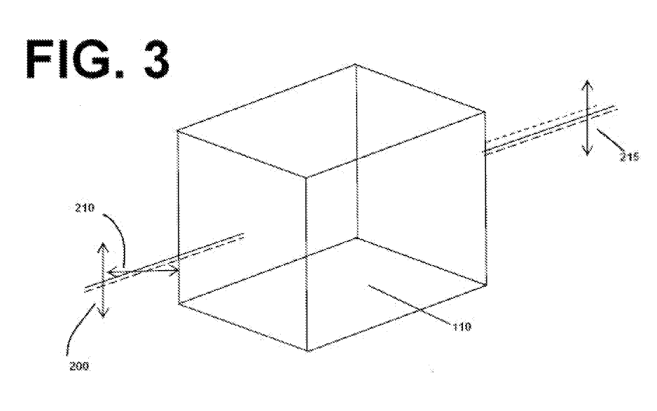

FIG. 4 shows a polarization bypass scheme utilizing Type I phase-matched SHG and Type I phase matched SFG.

FIG. 5 shows the third harmonic generation efficiency (THG) for setup one.

### DETAILED DESCRIPTION

The present invention relates to using a harmonic generator to create a third harmonic generation, wherein precise temperature stabilization of the harmonic generator (more than +/−1 K) is not required.

In one embodiment, the harmonic generator comprises at least one first non-linear optical element and at least one second non-linear optical element. The harmonic generator accomplishes third harmonic generation in a two step process, wherein the second step, the sum frequency generation (“SFG”), has a large phase-matching temperature bandwidth such that a temperature stabilization of the harmonic generator to +/−1 K is sufficient to achieve third harmonic generation with a conversion efficiency percentage between about twenty-five percent (25%) and about forty percent (40%) and stabilize that percentage within three percentage points.

### Harmonic Generator

Third harmonic generation (“THG”) requires generating a third harmonic of a fundamental wave. A first non-linear optical element is used to generate the second harmonic of a part of the available fundamental, deliberately sparing another part of the fundamental from conversion.

The sparing of a part of the fundamental wave can be accomplished by choosing a first non-linear optical element material shorter than required for highest possible conversion, rotating the polarization of the fundamental wave in a polarization-sensitive harmonic generator, spatially splitting the fundamental beam before first non-linear optical element, or other means know to those familiar with the art of frequency conversion.

Both the generated second harmonic and the remaining fundamental are then superimposed in a second non-linear optical element suited for efficient SFG of the two input beams. The SFG of the two input beams will yield a new field having the third harmonic frequency of the fundamental wave. The fundamental and second harmonic fields may be treated by suitable optics prior to entering the second non-linear optical element. This treatment may include, but is not limited to, one or more of the following applied to one or both beams: change of the polarization, refocusing, alteration of propagation direction, correction of temporal delay in case the fundamental laser is pulsed, or recombination of spatially separated beams.

To generate the fourth harmonic of a fundamental wave, a first non-linear device is used to generate a second harmonic wave without the requirement to spare a part of the fundamental wave. A second device is then used to generate a second harmonic of the second harmonic of the fundamental wave; i.e., the fourth harmonic of the fundamental wave. Once again suitable optical treatment of the second harmonic may be applied prior to entering the second crystal.

In all the aforementioned harmonic generation schemes, there may be residual parts of the fundamental or lower harmonic waves in the output beam due to limited conversion efficiency. These waves may be split off the wanted harmonic wave by suitable optics, like prisms, gratings, wavelength selective mirrors or filters, and other means.

### Components of the Invention

Embodiments of the invention may include various fundamental wavelengths, powers sources, non-linear crystals, phase-matching and polarization techniques, and angles and lengths for the harmonic generator components.

In one embodiment, the fundamental wavelength, λ₁, is between 1 μm and 1.1 μm. The first non-linear optical element is capable of producing a second harmonic wavelength, λ₂, between 0.5 μm and 0.55 μm, and the second non-linear element is capable of producing a third harmonic wavelength, λ₃, between 0.33 μm and 0.37 μm, with an average power of the THG greater than 5 W.

In another embodiment, the fundamental wavelength, λ₁, is equal to 1.03+/−0.005 μm, and the second harmonic wavelength, λ₂, is equal to 0.515+/−0.0025 μm, and λ₁ and λ₂ have the propagation direction of about θ=90° and about φ=40°, and λ₁ and λ₂ are ordinarily polarized.

The embodiments contemplate using lamp or diode pumped solid state lasers emitting in the wavelength range 1 μm to 1.1 μm. These lasers include, but are not limited to, Nd:YAG lasers (neodymium-doped yttrium aluminum garnet) emitting at 1.064 μm (1064 nm), Nd:YVO lasers (neodymium-doped yttrium vanadate) emitting at 1.064 μm (1064 nm), Nd:YLF lasers (neodymium-doped yttrium lithium fluoride) emitting at 1.047 μm (1047 nm) or 1.053 μm (1053 nm), and Nd:Glass (neodymium-doped glass) lasers emitting in the vicinity of 1.06 μm (1060 nm).

One embodiment uses a Yb:YAG-laser (ytterbium-doped yttrium aluminum garnet) emitting around 1.03 μm (1030 nm). The properties of this laser material are best suited for thin disk lasers where the difficulties of the three-level laser scheme are fully overcome.

The solid-state lasers may emit continuous waves, waves in a pulsed manner (typically by pulsing the current of the pump lamp or diode), or waves in a short pulsed manner (some 100 ps to several μs, typically by switching the Q factor of the resonator), or in an ultrashort pulsed manner (typically less than 100 ps, typically achieved by mode locking). The lasers may consist of oscillators, or combinations of oscillators and one or more stages of amplifiers, including regenerative amplifiers.

The solid-state lasers may also have an additional power modulation superimposed to their emission, which can be achieved in various ways, including, but not limited to, current modulation of oscillator or amplifier stages or variable attenuators in the output beam (e.g. acousto-optic modulators or electro-optic amplitude modulators, including combinations of Pockels-cells and polarizers).

The invention comprises non-linear crystals. A non-linear crystal as used in this invention is not limited to crystals, but may refer to any non-linear optic device or material displaying non-linear properties as described herein, including, but not limited to, LBO, BBO, cesium lithium borate (CsLiB₆O₁₀, “CLBO”) or other commonly available non-linear crystals. See Red Optronics, Product Index, http://www.redoptronics.com/product-index.html. In addition, the specific non-linear properties of the non-linear crystals such as the refractive index and dispersion properties can be altered during crystal growth by various means, including but not limited to crystal-doping. This invention furthers contemplates that entirely new non-linear crystals or material may be developed to obtain similarly large temperature bandwidths for harmonic generation.

The apparatus is not limited to one particular length of non-linear crystal and may use a crystal length ranging from about 2 mm to about 50 mm. In the present invention, the crystal length is determined by optimizing the conversion efficiency and phase-matching bandwidth, as these two factors vary inversely with length.

The embodiments require the input and output beams to be phas-matched in the overlap region of incident beams, i.e. their wave vectors k must satisfy with sufficient accuracy the condition:

kᵢₙ₁+kᵢₙ₂=kₛᵤₘ for SFG

kᵥ+k^{v}′=k₂ᵥ for SHG

Phase-matching can be achieved through the use of a birefringent, non-linear crystal, suitable for a given input wavelength(s) in certain propagation directions and polarization of the beams. The direction of beam propagation is described in a spherical coordinate system by the polar angle θ, between wave vector k and the crystal's principle z-axis, and the azimuth angle φ, between the crystal's x-axis and the projection of k onto the x-y plane.

Phase-matching can be either “Type I,” if the input beams are in the same polarization eigenstate, or “Type II,” if the input beams are in different polarization states.

Within every set of phase-matching solutions there is the possibility to continuously vary one of the propagation angles and φ or both of them in mutual dependency.

The accuracy that is required for phase matching depends on the length of the beam path in the non-linear crystal. For good conversion efficiency, it is required that |ΔkL| is sufficiently small, where Δk is the mismatch of the wave vectors, e.g. for collinear SFG, Δk=λ₁ₙ₁+λ₁ₙ₂−kₛᵤₘ, and L is the beam propagation length in the crystal.

When ΔkL varies from 0 to +/−2.874, the calculated small signal (non-depleted pump), infinite plane wave conversion efficiency of SHG and SFG drops to 50% of its peak value. Commonly this is used to define a full width at half maximum (“FWHM”) acceptance bandwidth for all parameters that have influence on Δk. These parameters include the frequency (or wavelength), the θ and φ directions of the input waves with respect to the crystal principal axes Z and X, and the temperature at which the refractive index ellipsoid of the non-linear crystal is affected.

These bandwidths depend inversely on L and are commonly given for the wavelengths (nm*cm), the direction (mrad*cm) and the temperature (K*cm). It is understood that for calculation or measurement of these bandwidths only one parameter is varied while all other are kept constant. The bandwidth may be defined on the condition −π<ΔkL<π. For practical purposes, the acceptable drop in conversion efficiency depends on the application. In technical high power THG setups, generally 30% conversion is a high value.

The tolerable bandwidth for the parameters is much smaller than the FWHM bandwidth. If, for example, the small signal efficiency must not drop below 3% of its maximum, the parameters have to be confined to a band of about one fifth of the FWHM. Taking into account the effects of the input beam depletion at high conversion efficiency, the tolerable parameter bandwidths will be even smaller.

The harmonic generator may also comprise a temperature stabilization mechanism that may stabilize the temperature within +/−1 K. Various means of temperature stabilization known in the art may be incorporated into the system, but the system will not require a more precise temperature stabilization than +/−1 K.

Temperature stabilization of the harmonic generator to within +/−1 K is given the meaning of temperature stabilization known in the art. For example, as in an embodiment of the invention featuring a water chiller, temperature stabilization may mean the water temperature of the water chiller is stabilized to within +/−1 K. See U.S. Laser Corporation, Product Catalog (Jan. 11, 2011), available at http://www.uslasercorp.com/catalog/chillers.html.

The large temperature bandwidth of the harmonic generator removes the need for more precise temperature stabilization such as +/−0.1 K or +/−0.01 K found in other harmonic generators, and may allow the system to function without any temperature stabilization. In addition, the harmonic generator does not require a continuous temperature feedback system as described in U.S. Pat. No. 6,697,390 to Kafka et al. for precise temperature stabilization, or temperature stabilization particular to any component within the harmonic generator.

In addition, a delayed or distorted modulation of the generated harmonic due to the thermal reaction time of the system will not prevent the third harmonic generation from stabilizing at a percent between about twenty-five percent (25%) and about forty percent (40%).

Furthermore, the conversion efficiency percentage will not vary by more than about three percentage points during the third harmonic generation. For the purposes of this measurement, the third harmonic generation is the time period in which the harmonic generator is used to produce the third harmonic generation for its intended purpose.

Furthermore, temperature gradients across the harmonic generator, including the non-linear crystals, will not prevent the conversion efficiency of the third harmonic generation from stabilizing between about twenty-five percent (25%) and about forty percent (40%).

### Increased Temperature Bandwidth

In one embodiment of the invention, the system has a large temperature bandwidth (47 K) at a convenient temperature (around 320 K), which was more than double the temperature bandwidth predicted in simulations. Due to the larger than expected temperature bandwidth, precise temperature stabilization of non-linear crystal is not needed.

SNLO, a widely used simulator developed by Sandia National Laboratories, which calculates the expected temperature bandwidth for various systems, predicts one embodiment the invention (14 mm LBO for SHG and 7-mm long LBO with Type I phase matching for SFG, with λ₁=1030 nm and λ₂=515 nm) to have a temperature bandwidth of 23 K, whereas the present invention obtains the temperature bandwidth of 47 K as shown below.

THG of a 1030 nm laser beam at 50 W average input power (14 mm
LBO for SHG and 7-mm LBO, Type I Phase Matching for SFG

| | SNLO | |
|---|---|---|
| | Projection for | |
| | the Present | Present |
| | Invention | Invention |
| crystal length/ | 0.7 | 0.7 |
| cm | | |
| Initial Temp. | 47 | 54 |
| (° C.) | | |
| −π < ΔkL < π. | 25.9 | 53.1 |
| FWHM | 23 | 47 |
| bandwidth | | |

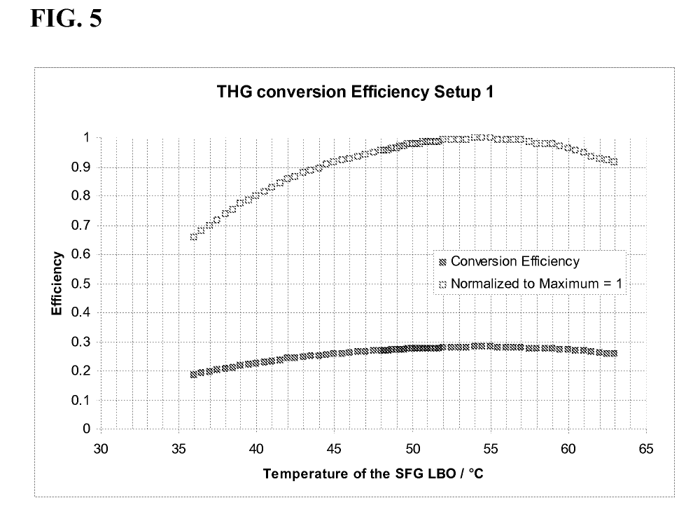

Due to the greater temperature bandwidths of the present invention, precise temperature stabilization is not required. Moreover, the conversion efficiency percentage remains near thirty percent (30%) at convenient temperatures as well as being stabilized within three percentage points of the conversion efficiency percentage as shown in FIG. 5.

### Apparatus Set-Up

To obtain the large phase-matching temperature bandwidth of the invention, one particular embodiment uses a special fundamental wavelength λ₁ 100 in combination with an apparatus which may contain nonlinear crystals 105, 110 for frequency conversion, a determined propagation direction 220 and polarization of the fundamental wavelength 200 and the second harmonic beam 210, and a predetermined optimal temperature of the nonlinear crystal for phase matching such as between about 20°, and about 60° C., between about 20° and about 50° C., and between about 20° and about 45° C., wherein the phase matching will occur within about +/−30 K, +/−40 K, of +/−45 K of the optimal temperature of the crystal.

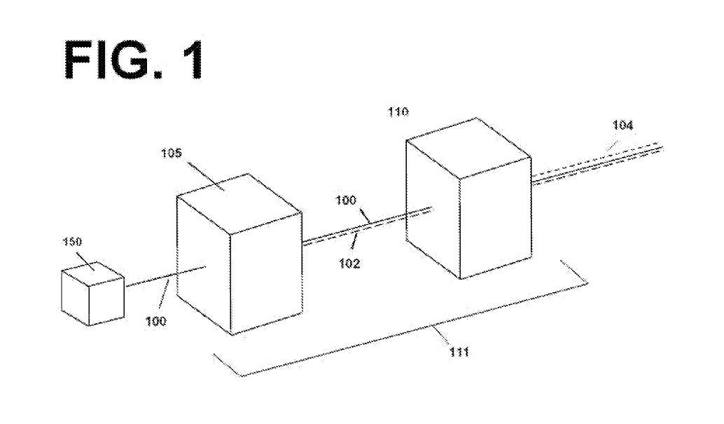

FIG. 1 shows an embodiment of a harmonic generator 111, which is created by two non-linear (birefringent) crystals 105, 110 set in series. The laser source 150 creates a fundamental wavelength, λ₁ 100. The first non-linear crystal 105 produces a second harmonic wavelength, λ₂ 102, overlapping fundamental wavelength, λ₁ 100. The second non-linear crystal 110 produces a third harmonic wave, λ₃ 104, overlapping fundamental wavelength, λ₁ 100, and second harmonic wavelength, λ₂ 102. Following the second non-linear crystal 110, the residual fundamental wavelength, λ₁ 100, and second harmonic wavelength, λ₂ 102, can be separated from the third harmonic by any means of spectral decomposition such as prisms, gratings, filters or spectrally discriminating mirrors. In other embodiments, polarization discrimination may also be used.

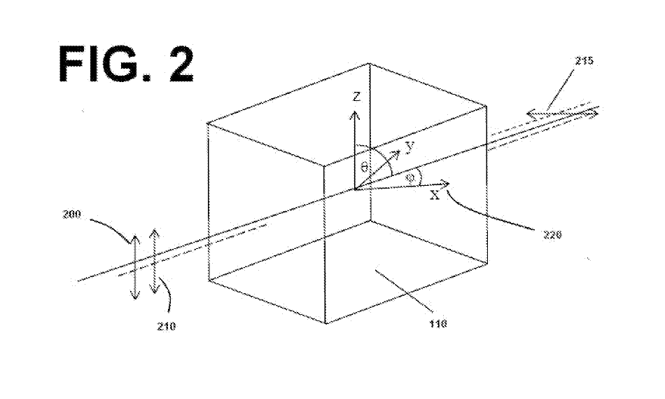

In an embodiment of the system, the fundamental laser beam has a wavelength 100 of about 1030 nm (1.030 μm). A part of the fundamental beam will be converted by a non-linear crystal 105 into a second harmonic beam with the wavelength 102 of about 515 nm (0.515 μm). An LBO or similar non-linear crystal 110 may be used for the conversion of the third harmonic generation 104. As shown in FIG. 2, prior to the third harmonic generation 104, the non-converted fundamental beam polarization 200 and the converted second harmonic beam polarization 210 will have, or will be treated to have, the same polarization, comprising Type I SFG using an LBO crystal 110.

The fundamental beam 100 and second harmonic 102 have the same propagation direction 220, based on the crystal's principal axis, θ=90°, φ=40°, and the harmonics are ordinarily polarized. In addition, θ and φ may have a tolerances of +/−5° and +/−3° respectively. In addition, the length of the LBO 110 is seven millimeters long in the propagation direction. The polarization of third harmonic wave, λ₃, 215 will be perpendicular to the non-converted fundamental beam polarization 200 and the converted second harmonic beam polarization 210.

In this particular embodiment, phase matching will be achieved near 320 K (47° C.) with a temperature bandwidth of 30 K or larger. This particular embodiment will have no spatial or temporal reduction of the conversion efficiency due to temperature changes in the crystal because the phase matching temperature bandwidth is much larger than the temperature changes occurring in the crystal. In addition, no deformed output beam and delayed modulation response at high powers occur, allowing a fast switch on and off of the laser output beam.

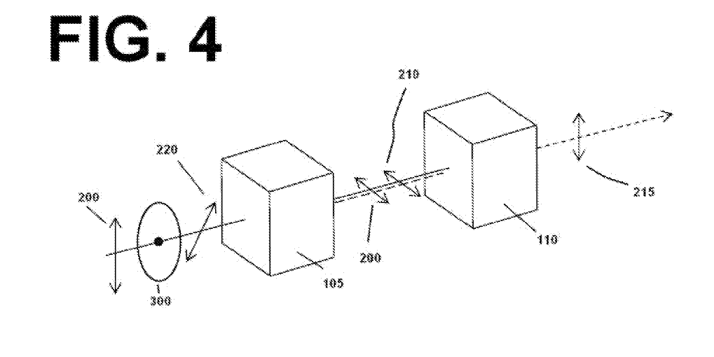

In another embodiment, as shown in FIG. 4, a collimated beam of picosecond pulses having a fundamental wavelength of 1030 nm is used. The fundamental beam's polarization 200 is rotated by passing a half wave plate 300 limiting the amount of the beam that has the polarization along the ordinary axis of the first nonlinear crystal 105. A Type I phase matching non-linear crystal 105 will convert only this part into a second harmonic beam having a wavelength of 515 nm. The fundamental beam, which passes through the non-linear crystal without being converted and the second harmonic beam have the same polarization 200, 210. Both beams continue through a second non-linear crystal 110 with Type I phase matching in which they overlap to produce a third harmonic beam by SFG with perpendicular polarization 215, wherein the SFG non-linear crystal 110 has a temperature of 320 K and shows a temperature bandwidth of more then 30 K.

In one embodiment of the invention, the SHG (first crystal) 105 may be chosen to be BBO, which is known to have an extraordinarily large temperature bandwidth for the SHG 105 of near 1 μm wavelength radiation. LBO may be chosen as SFG (second non-linear crystal) 110 as described above. This combination allows for THG without active temperature stabilization in both the SHG 105 and SFG 110 crystal.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An apparatus for producing an ultraviolet wavelength from an infrared fundamental wavelength through third harmonic generation, comprising:
a source of a fundamental wavelength, λ₁; and
a harmonic generator, wherein temperature stabilization of the harmonic generator to +/−1 K is sufficient to realize a third harmonic generation conversion efficiency percentage between about twenty-five percent to about forty percent, and
wherein the conversion efficiency percentage does not vary by more than about three percentage points during the third harmonic generation.

2. The apparatus of claim 1, wherein the harmonic generator comprises at least one first non-linear optical element and at least one second non-linear optical element.

3. The apparatus of claim 1, wherein fundamental wavelength, λ₁, is between about 1 μm and about 1.1 μm.

4. The apparatus of claim 1, wherein the fundamental wavelength, λ₁, is equal to 1.03+/−0.005 μm.

5. The apparatus of claim 2, wherein first non-linear optical element is capable of producing a second harmonic wavelength, λ₂, between about 0.5 μm and about 0.55 μm, and wherein the second non-linear element is capable of producing a third harmonic wavelength, λ₃, between about 0.33 μm and about 0.37 μm.

6. The apparatus of claim 5, wherein the fundamental wavelength, λ₁, is equal to 1.03+/−0.005 μm, and the second harmonic wavelength, λ₂, is equal to 0.515+/−0.0025 μm.

7. The apparatus of claim 5, wherein λ₁ and λ₂ have the propagation direction of about θ=90°+/−5° and about φ=40°+/−3° and λ₁ and λ₂ are ordinarily polarized.

8. The apparatus of claim 5, wherein the average power of the third harmonic generation is greater than 5 W.

9. The apparatus of claim 5, wherein the specific full width at half maximum temperature bandwidth of the sum frequency generation is between about 27 K*cm and about 50 K*cm.

10. The apparatus of claim 5, wherein the apparatus has a central phase-matching temperature of about 20° C. to about 60° C.

11. The apparatus of claim 5, wherein the beam distortion, M², is less than about 1.3.

12. The apparatus of claim 5, wherein at least one of the first or the second non-linear optical element comprises lithium triborate.

13. The apparatus of claim 5, wherein at least one of the first or the second non-linear optical element comprises beta-barium borate.

14. A method for producing an ultraviolet wavelength from an infrared fundamental wavelength, comprising:
producing a fundamental wavelength;
producing a second harmonic wavelength, λ₂, at a first optical element;
producing a third harmonic wavelength, λ₃, at a second optical element;
stabilizing the temperature to within +/−1 K; and
producing a conversion efficiency percentage for third harmonic generation between about twenty-five percent to about forty percent, and wherein the conversion efficiency percentage does not vary by more than about three percentage points during the third harmonic generation.

15. The method of claim 14, wherein the second harmonic wavelength, λ₂, is between about 0.5 μm and about 0.55 μm, and the third harmonic wavelength, λ₃, is between about 0.33 μm and about 0.37 μm.

16. The method of claim 14, wherein the fundamental wavelength, λ₁, is equal to 1.03+/−0.005 μm, and the second harmonic wavelength, λ₂, is equal to 0.515+/−0.0025 μm.

17. The method of claim 14, wherein λ₁ and λ₂ are propagated at about θ=90°+/−5° and φ=40°+/−3° and λ₁ and λ₂ are ordinarily polarized.

18. The method of claim 14, wherein at least one of the first or the second non-linear optical element comprises lithium triborate.

19. The method of claim 14, wherein at least one of the first or the second non-linear optical element comprises beta-barium borate.

20. The method of claim 14, wherein the specific full width at half maximum temperature bandwidth of the third harmonic generation is between about 27 K*cm and about 50 K*cm.
